(19) United States
(12) Patent Application Publication
(10) Pub. No.: US 2017/0277269 A1
(43) Pub. Date: Sep. 28, 2017

(54) DISPLAY CONTROL DEVICE, DISPLAY CONTROL METHOD, AND NON-TRANSITORY COMPUTER-READABLE RECORDING MEDIUM

(71) Applicant: CASIO COMPUTER CO., LTD., Tokyo (JP)

(72) Inventors: Kazuma KAWAHARA, Tokyo (JP); Toshihiko YOSHIDA, Tokyo (JP); Yoichi MURAYAMA, Tokyo (JP); Gou KAWAKAMI, Tokyo (JP); Takashi KAWASHIMO, Tokyo (JP); Hiroaki SHIMODA, Tokyo (JP)

(73) Assignee: CASIO COMPUTER CO., LTD., Tokyo (JP)

(21) Appl. No.: 15/370,774

(22) Filed: Dec. 6, 2016

(30) Foreign Application Priority Data
Mar. 23, 2016 (JP) 2016-057843

(51) Int. Cl. G06F 3/01

(52) U.S. Cl. CPC G06F 3/017

(57) ABSTRACT

The display control device includes: a distance acquirer acquiring a distance between a display surface on which an item is displayed and an operator operating the item; and a display controller displaying on the display surface an item belonging to a hierarchy level corresponding to the distance acquired by the distance acquirer from an item group including multiple hierarchized items.

### CROSS-REFERENCE TO RELATED APPLICATION

This application claims the benefit of Japanese Patent Application No. 2016-057843, filed on Mar. 23, 2016, the entire disclosure of which is incorporated by reference herein.

### FIELD

This application relates generally to a display control device, display control method, and non-transitory computer-readable recording medium.

### BACKGROUND

In the prior art, display systems detecting motion of a user with a camera and operating an operation target displayed on a screen in accordance with the detected motion are provided. As an operation aid for the user in such display systems, for example, Unexamined Japanese Patent Application Kokai Publication No. 2013-210723 discloses a display system enabling various operations in accordance with the shape of a user's hand in which shapes of a hand corresponding to operations are displayed on a screen as an operation guide.

However, the display system displays the operation guide for all operations available on the screen. Therefore, when many operable items are displayed on the screen such as a menu screen, the screen is complicated; thus, a problem is that it takes the user a while to access an item he wants to display.

The present disclosure is made with the view of the above circumstance and an objective of the disclosure is to provide a display control device and the like enabling the user to easily access an item he wants to display.

### SUMMARY

In order to achieve the above objective, the display control device according to the present disclosure comprises:

a distance acquirer acquiring a distance between a display surface on which an item is displayed and an operator operating the item; and

a display controller displaying on the display surface an item belonging to a hierarchy level corresponding to the distance acquired by the distance acquirer from an item group including multiple hierarchized items.

### BRIEF DESCRIPTION OF THE DRAWINGS

A more complete understanding of this application can be obtained when the following detailed description is considered in conjunction with the following drawings, in which:

FIG. 1 is an illustration showing the appearance configuration of a display control system according to an embodiment;

FIG. 2 is an illustration showing exemplary contents displayed by a display device;

FIG. 3 is an illustration schematically showing an item data structure;

FIG. 4 is a schematic diagram showing the configuration of the display control device;

FIG. 5 is a chart for explaining an example of an item display method;

FIG. 6A is an illustration showing exemplary items displayed on a display surface;

FIG. 6B is an illustration showing exemplary items displayed on the display surface; and

FIG. 7 is an illustration showing an exemplary flowchart of a display control procedure.

### DETAILED DESCRIPTION

An embodiment of the present disclosure will be described hereafter with reference to the drawings.

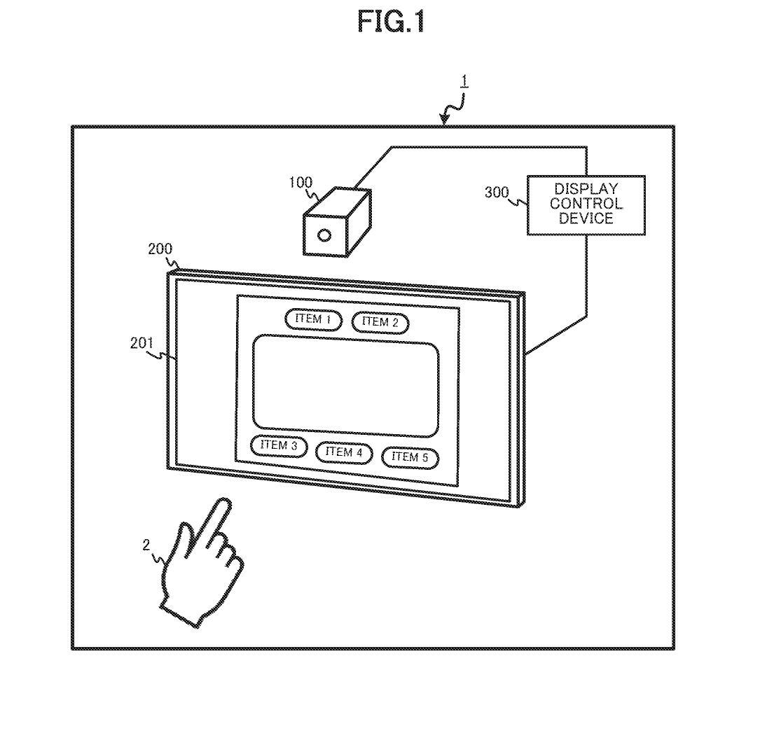

FIG. 1 is an illustration showing the appearance configuration of a display control system 1 according to an embodiment of the present disclosure. The display control system 1 is a system installed at store fronts or in public facilities and controlling digital signage (so-called electronic signs) displaying contents such as guidance and advertisements to the users or viewers.

As shown in FIG. 1, the display control system 1 comprises a motion sensor 100, a display device 200, and a display control device 300. The display control system 1 utilizes a so-called gesture interface for operating operation targets displayed on the display device 200. Here, the gesture interface is a user interface for transferring information from the user to the computer with motion of a hand or finger (gesture). In other words, in the display control system 1, the display control device 300 detects motion of a user's hand 2 functioning as an operator in this embodiment by means of the motion sensor 100 and executes a procedure on an operation target displayed on the display device 200 in accordance with the motion. Then, the display control device 300 displays the execution result on the display device 200.

The motion sensor 100 comprises, for example, a distance image sensor utilizing infrared or laser. The motion sensor 100 is installed in front of the user or below the user's hand 2 so that the user's hand 2 is placed within the field angle and acquires distance image data. The distance image data include data presenting the shape of a measurement target, the distance to the measurement target, and the position of the measurement target. The motion sensor 100 sends the acquired distance image data to the display control device 300.

As a method of acquiring the above distance image date, for example, the motion sensor 100 comprises two imaging devices. In such a case, using conventional stereo image processing techniques, distance image data can be obtained from the parallax between images captured individually by the two imaging devices.

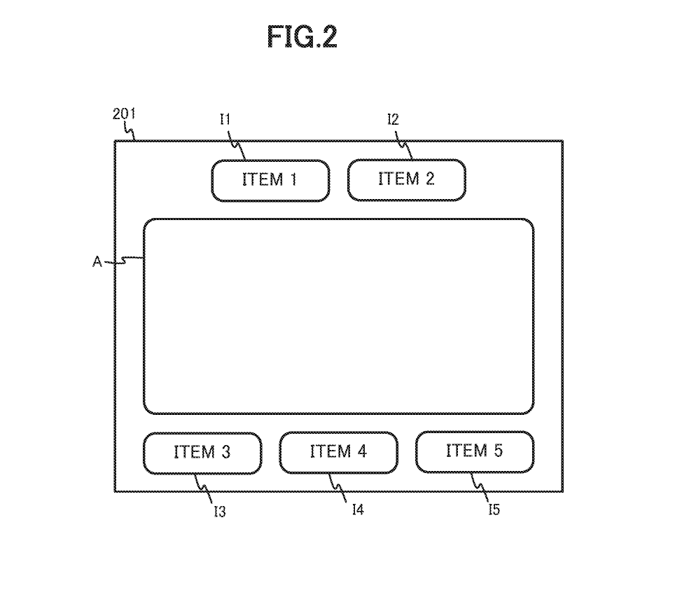

The display device 200 is a device displaying contents output from the display control device 300 and comprises, for example, a liquid crystal display (LCD), electroluminance (EL) display, or the like. In this embodiment, the display device 200 displays on a display surface 201 contents including operation targets. An example of the contents displayed by the display device 200 are shown in FIG. 2. In the example shown in FIG. 2, items I1 to I5 that are operation targets and a display region A in which items relating to the items I1 to I5 are to be displayed are displayed on the display surface 201.

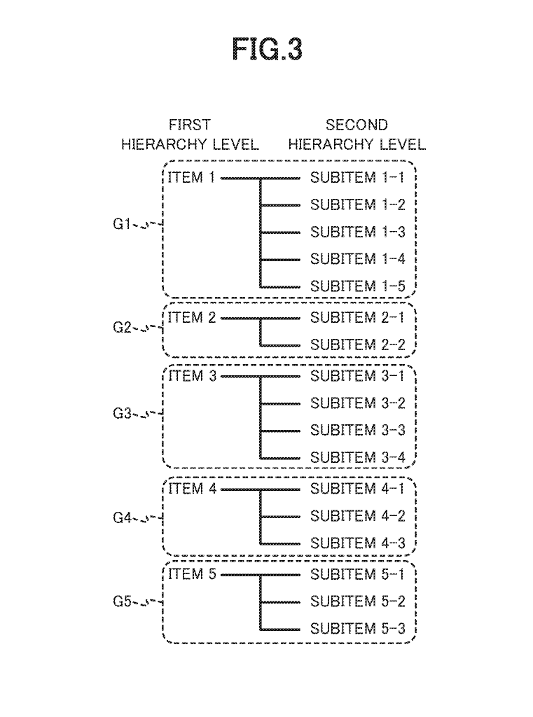

Here, the data structure of items displayed in the display control system 1 according to this embodiment is described. FIG. 3 is an illustration schematically showing the item data structure according to this embodiment. As shown in FIG. 3, the item data structure according to this embodiment comprises item groups G1 to G5 including multiple hierarchized items.

The multiple items include “ITEM 1” to “ITEM 5” and “SUBITEM 1-1” to “SUBITEM 1-5,” “SUBITEM 2-1” to “SUBITEM 2-2,” “SUBITEM 3-1” to “SUBITEM 3-4,” “SUBITEM 4-1” to “SUBITEM 4-3,” and “SUBITEM 5-1” to “SUBITEM 5-3.” The “SUBITEM 1-1” to “SUBITEM 1-5” are items relating to the “ITEM 1” and, for example, items presenting detailed contents of the “ITEM 1.” The “SUBITEM 2-1” to “SUBITEM 2-2” are items relating to the “ITEM 2” and, for example, items presenting detailed contents of the “ITEM 2.” The “SUBITEM 3-1” to “SUBITEM 3-4” are items relating to the “ITEM 3” and, for example, items presenting detailed contents of the “ITEM 3.” The “SUBITEM 4-1” to “SUBITEM 4-3” are items relating to the “ITEM 4” and, for example, items presenting detailed contents of the “ITEM 4.” The “SUBITEM 5-1” to “SUBITEM 5-3” are items relating to the “ITEM 5” and, for example, items presenting detailed contents of the “ITEM 5.”

The item groups G1 to G5 are each presented by a tree structure of which the nodes are items. In the following explanation, “an immediate superior item” corresponds to a parent node in a tree structure. For example, in FIG. 3, the immediate superior item of the “SUBITEM 1-1” is the “ITEM 1.” Moreover, “an immediate subordinate item” corresponds to a child node in a tree structure. For example, in FIG. 3, the immediate subordinate items of the “ITEM 1” are the “SUBITEM 1-1” to “SUBITEM 1-5.”

Moreover, the multiple items each belong to a hierarchy level corresponding to their position in the tree structure. In this embodiment, the “ITEM 1” to “ITEM 5” belong to the first hierarchy level. Moreover, the “SUBITEM 1-1” to “SUBITEM 1-5,” the “SUBITEM 2-1” to “SUBITEM 2-2,” the “SUBITEM 3-1” to “SUBITEM 3-4,” the “SUBITEM 4-1” to “SUBITEM 4-3,” and the “SUBITEM 5-1” to “SUBITEM 5-3” belong to the second hierarchy level. In the following explanation, “being deeper in the hierarchy” refers to being at a higher hierarchy level.

Returning to FIG. 1, the display control device 300 displays on the display surface 201 of the display device 200 the items belonging to a hierarchy level corresponding to the distance between the display surface 201 and user's hand 2 based on the distance image data acquired from the motion sensor 100.

The configuration of the display control device 300 will be described in detail hereafter.

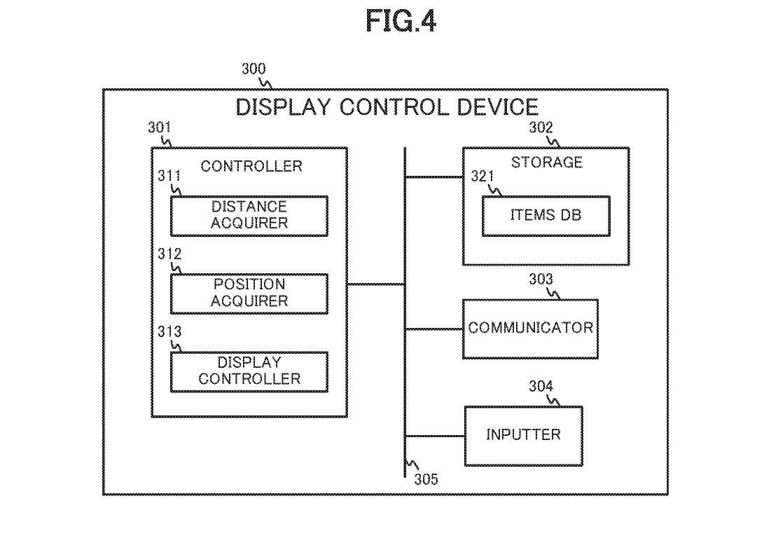

FIG. 4 is a schematic diagram showing the configuration of the display control device 300. As shown in FIG. 4, the display control device 300 comprises a controller 301, a storage 302, a communicator 303, and an inputter 304, which are connected by a bus 305.

The controller 301 comprises a central processing unit (CPU), a read only memory (ROM), and a random access memory (RAM). The controller 301 executes programs stored in the ROM (for example, a program regarding the display control procedure described later) to realize the functions of a distance acquirer 311, position acquirer 312, and display controller 313 described later.

The storage 302 is a nonvolatile memory such as a hard disk drive (HDD). The storage 302 stores various contents that are output to the display device 200. Moreover, the storage 302 stores an items database (DB) 321 saving multiple items constituting the item groups G1 to G5 in a mutually associated manner so as to form the data structure as shown in FIG. 3.

The communicator 303 comprises a communication interface for communicably connecting the display control device 300 to the motion sensor 100 and display device 200.

The inputter 304 comprises an input device such as buttons, a keyboard, or a touch panel. The inputter 304 receives operation input from the user of the display control device 300 and outputs to the controller 301 signals corresponding to the received operation input.

The functional configuration of the controller 301 of the display control device 300 will be described hereafter. As shown in FIG. 4, the controller 301 functions as the distance acquirer 311, the position acquirer 312, and the display controller 313.

The distance acquirer 311 acquires the distance between the display surface 201 and user's hand 2. In this embodiment, the distance acquirer 311 acquires distance image data from the motion sensor 100. Then, the distance acquirer 311 acquires the distance between the user's hand 2 and display surface 201 in the real space from, for example, the acquired distance image data. Here, the position of the user's hand 2 may be, for example, the position of the tip of an extended finger of the user's hand 2 or the position of a part of the user's hand 2 that is closest to the display surface 201.

The position acquirer 312 acquires the position of the user's hand 2 on the display surface 201 from the distance image data acquired by the motion sensor 100. For example, the position of the user's hand 2 on the display surface 201 can be acquired based, for example, on the parallax obtained from images captured individually by two imaging devices provided to the motion sensor 100. In this embodiment, a position on the distance image data acquired by the motion sensor 100 and a position on the display surface 201 of the display device 200 are associated in advance. The position acquirer 312 acquires a position on the display surface 201 corresponding to the position of the user's hand 2 identified on the acquired distance image data as the position of the user's hand 2 on the display surface 201.

The display controller 313 displays on the display surface 201 items belonging to a hierarchy level corresponding to the distance acquired by the distance acquirer 311 from among the item groups G1 to G5 saved in the items DB 321. In this embodiment, the display controller 313 displays on the display surface 201 items deeper in the hierarchy as the distance acquired by the distance acquirer 311 is shorter, in other words as the user's hand 2 and display surface 201 are closer in distance.

Here, an example of the item display method executed by the display controller 313 is described. In this example, the display controller 313 displays on the display surface 201 the immediate subordinate items of the item corresponding to the position on the display surface 201 acquired by the position acquirer 312 when the distance acquired by the distance acquirer 311 falls below a given threshold. Moreover, the display controller 313 displays on the display surface 201 the immediate superior item of the items displayed on the display surface 201 when the distance acquired by the distance acquirer 311 exceeds a given threshold.

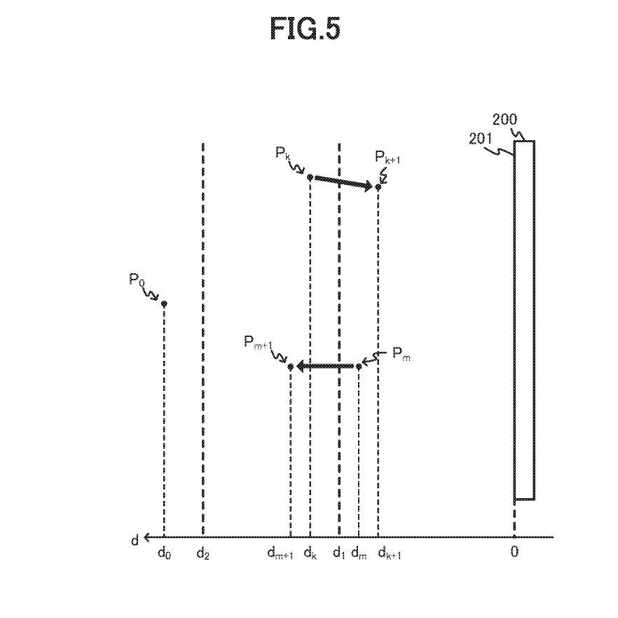

The above example will be described in detail hereafter. FIG. 5 is an illustration seen in the direction perpendicular to the display surface 201, in which distances d are defined in the direction of display (forward) from the display surface 201 with d=0 at the position of the display surface 201. Then, a first threshold (a given threshold) is preset where d=d1 and a second threshold where d=d2.

As shown in FIG. 5, when the user's hand 2 is positioned at a point P0, the distance acquirer 311 acquires a distance d=d0. In such a case, since the acquired distance d0 is larger than the second threshold d2, the display controller 313 maintains the display of the items I1 to I5 (“ITEM 1” to “ITEM 5”) belonging to the first hierarchy level on the display surface 201 as shown in FIG. 2.

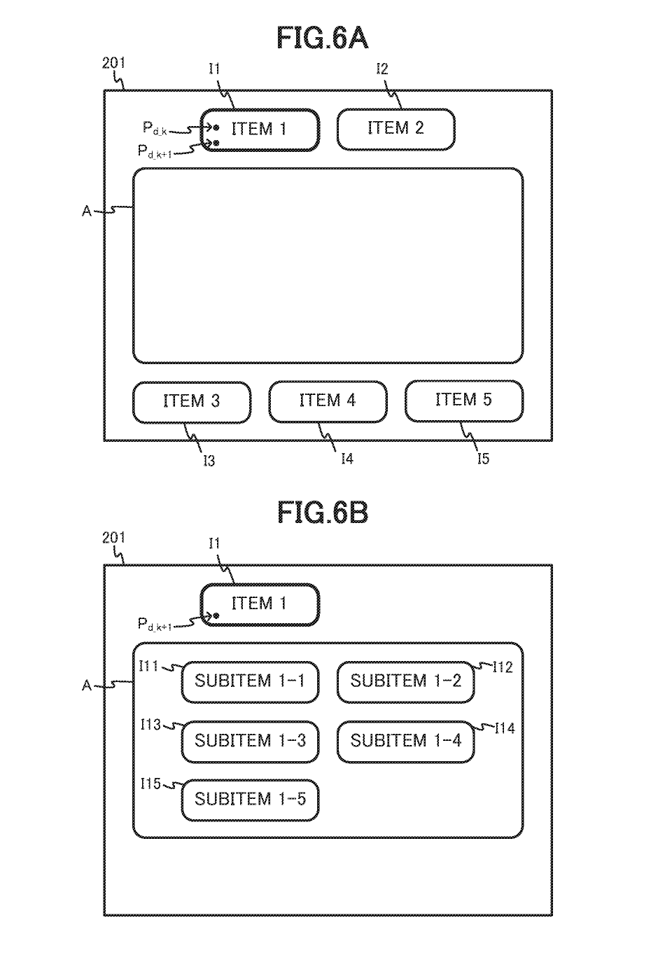

On the other hand, when the user's hand 2 is positioned at a point Pk, the distance acquirer 311 acquires a distance d=dk. Furthermore, the position acquirer 312 acquires a position Pd_k of the user's hand 2 on the display surface 201 as shown in FIG. 6A. In such a case, the acquired distance dk is smaller than the second threshold d2 and larger than the first threshold d1. Then, as shown in FIG. 6A, the display controller 313 makes the outline of the item I1 displayed at the position Pd_k acquired by the position acquirer 312 thicker than those of the other items 12 to I5 for highlighting.

Moreover, when the user's hand 2 moves from the point Pk to a point Pk+1, the distance acquirer 311 acquires a distance d=dk+1. Furthermore, the position acquirer 312 acquires a position Pd_k+1 of the user's hand 2 on the display surface 201 as shown in FIGS. 6A and 6B. In such a case, the display controller 313 determines that the distance acquired by the distance acquirer 311 falls below the first threshold d1 because the acquired distance dk+1 is smaller than the first threshold d1 and the distance dk acquired immediately before is larger than the first threshold d1. Then, the display controller 313 identifies, with reference to the items DB 321, the immediate subordinate items of the item I1 displayed at the position Pd_k+1 acquired by the position acquirer 312. In this case, as shown in FIG. 3, the immediate subordinate items of the item I1 (“ITEM 1”) are “SUBITEM 1-1” to “SUBITEM 1-5.” Therefore, the display controller 313 displays in the display region A items I11 to 115 (“SUBITEM 1-1” to “SUBITEM 1-5”) as shown in FIG. 6B. Moreover, the display controller 313 deletes from the display surface 201 the items I2 to I5 corresponding to the other items “ITEM 2” to “ITEM 5” belonging to the same hierarchy level as the “ITEM 1,” namely the first hierarchy level.

Moreover, when the user's hand 2 is positioned at a point Pm and then moved to a point Pm+1 while the items I11 to 115 (“SUBITEM 1-1” to “SUBITEM 1-5”) that are the immediate subordinate items of the item I1 (ITEM 1) are displayed on the display surface 201 as shown in FIG. 6B, the distance acquirer 311 acquires a distance d=dm+1. In such a case, the display controller 313 determines that the distance acquired by the distance acquirer 311 exceeds the first threshold d1 because the acquired distance dm+1 is larger than the first threshold d1 and the distance dm at the point Pm acquired immediately before is smaller than the first threshold d1. Then, the display controller 313 displays on the display surface 201 the item I1 (“ITEM 1”) that is the immediate superior item of the items I11 to 115 (“SUBITEM 1-1” to “SUBITEM 1-5”) displayed on the display surface 201 and the other items 12 to I5 (“ITEM 2” to “ITEM 5”) belonging to the same hierarchy level as the item I1 (“ITEM 1”), namely the first hierarchy level as shown in FIG. 6A.

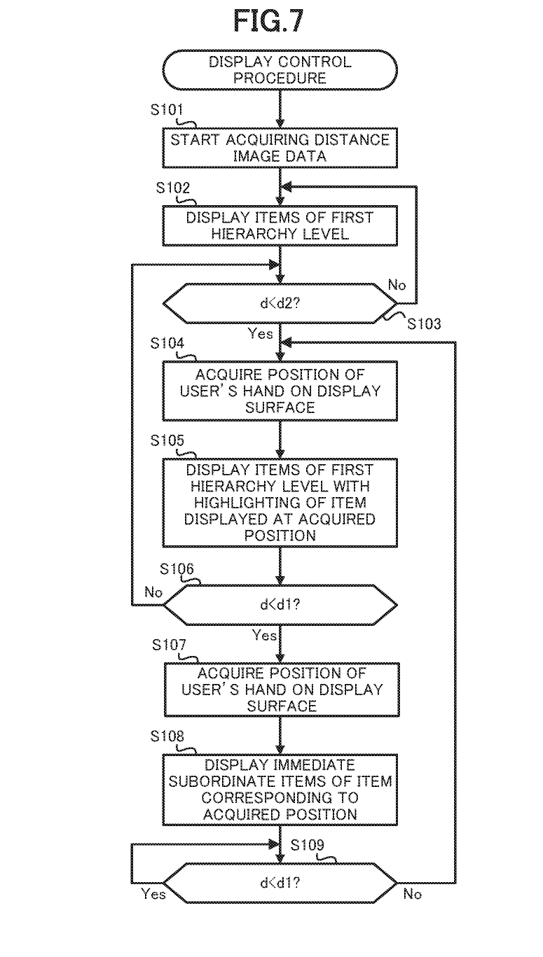

The display control procedure executed by the controller 301 of the display control device 300 according to this embodiment will be described hereafter. FIG. 7 is an exemplary flowchart of the display control procedure according to this embodiment. This display control procedure starts when the display control device 300 is powered on. Moreover, for easier understanding, the explanation will be made on the assumption that the motion sensor 100 takes measurements of only one user.

First, the distance acquirer 311 starts acquiring distance image data from the motion sensor 100 (Step S101). Subsequently, the distance acquirer 311 acquires distance image data at given time intervals and records the acquired distance image data on the RAM or the like. Then, each time distance image data are acquired, the distance acquirer 311 identifies the position of the user's hand 2 on the distance image data, and acquires the distance between the user's hand 2 and the display surface 201 of the display device 200 in the real space from the identified position of the user's hand 2. Then, the distance acquirer 311 records the acquired distance on the RAM or the like.

Then, the display controller 313 displays on the display surface 201 of the display device 200 the items I1 to I5 (“ITEM 1” to “ITEM 5”) belonging to the first hierarchy level as shown in FIG. 2 with reference to the items DB 321 (Step S102).

Then, the display controller 313 determines whether the latest distance d acquired by the distance acquirer 311 is smaller than the second threshold d2 (Step S103). If the distance d is not smaller than the second threshold d2 (Step S103; No), the display controller 313 returns to the Step S102 and continues to display the items I1 to I5 belonging to the first hierarchy level until it is determined that the distance d is smaller than the second threshold d2.

If the distance d is smaller than the second threshold d2 (Step S103; Yes), the position acquirer 312 identifies from the acquired latest distance image data the position of the user's hand 2 on those distance image data. Then, the position acquirer 312 acquires a position of the user's hand 2 on the display surface 201 corresponding to the identified position of the user's hand 2 on the distance image data (Step S104).

Then, the display controller 313 displays the items belonging to the first hierarchy level on the display surface 201 with highlighting of the item displayed at the position of the user's hand 2 on the display surface 201 acquired in the Step S104 (Step S105).

Then, the display controller 313 determines whether the latest distance d acquired by the distance acquirer 311 is smaller than the first threshold d1 (Step S106). If the distance d is not smaller than the first threshold d1 (Step S106; No), the display controller 313 returns to the Step S103 and continues to display the items belonging to the first hierarchy level with highlighting of the item displayed at the position of the user's hand 2 on the display surface 201.

If the distance d is smaller than the first threshold d1 (Step S106; Yes), the position acquirer 312 identifies from the acquired latest distance image data the position of the user's hand 2 on those distance image data. Then, the position acquirer 312 acquires a position of the user's hand 2 on the display surface 201 corresponding to the identified position of the user's hand 2 on the distance image data (Step S107).

Then, the display controller 313 identifies, with reference to the items DB 321, the immediate subordinate items of an item corresponding to the position of the user's hand 2 on the display surface 201 acquired in the Step 107, and displays the identified items in the display region A of the display surface 201 (Step S108). Moreover, the display controller 313 deletes from the display surface 201 the items belonging to the same, first hierarchy level as the item corresponding to the acquired position of the user's hand 2 on the display surface 201 except for that item.

Then, the display controller 313 determines whether the latest distance d acquired by the distance acquirer 311 is smaller than the first threshold d1 (Step S109). If the distance d is smaller than the first threshold d1 (Step S109; Yes), the display controller 313 continues to display the items belonging to the second hierarchy level in the display region A. On the other hand, if the distance d is not smaller than the first threshold d1 (Step S109; No), the display controller 313 ends the display of the items belonging to the second hierarchy level in the display region A, returns to the Step S104, and displays the items belonging to the first hierarchy level.

The above procedure is repeatedly executed until, for example, the display control device 300 is powered off or operation input presenting the end of the display control procedure is received from the user via the inputter 304.

As described above, the display control device 300 according to this embodiment acquires the distance between the display surface 201 on which items are displayed and the user's hand 2 operating the items, and displays on the display surface 201 the items belonging to a hierarchy level corresponding to the acquired distance. Therefore, the user can easily access an item belonging to any hierarchy level by moving the hand 2 forward or backward while viewing the items displayed on the display surface 201 in front of him.

Moreover, the display control device 300 according to this embodiment displays on the display surface 201 items deeper in the hierarchy as the acquired distance is shorter, in other words as the user's hand 2 and display surface 201 is closer in distance. Therefore, the user can access intuitively the hierarchy level to which an item he wants belongs.

Moreover, the display control device 300 according to this embodiment displays on the display surface 201 the immediate subordinate items of an item corresponding to the position of the user's hand 2 on the display surface 201 when the acquired distance falls below a given threshold, in other words when the distance between the user's hand 2 and display surface 201 becomes smaller than a given distance. Therefore, the user can easily select from among multiple items displayed on the display surface 201 an item of which the immediate subordinate items (subitems) he wants to display and display the subitems.

An embodiment is described above. The above embodiment is given by way of example and the specific configuration of the display control device 300 and details of the display control procedure are not confined to what is described in the above embodiment, and can be modified as follows.

The display control system 1 according to the above embodiment acquires distance image data from the motion sensor 100 and acquires the distance between the display surface 201 and user's hand 2 from the acquired distance image data by way of example. However, the method of acquiring the distance between the display surface 201 and user's hand 2 is not restricted thereto. For example, one of the following methods can be employed. One method is called the light coding method in which a known optical pattern is emitted within the field angle and the distance image data of a measurement target within the field angle are acquired from distortion of the reflection pattern. The other method is the time of flight (TOF) method in which the distance image data of a measurement target is acquired by measuring on each pixel the time of emitted light being reflected on the measurement target and returning.

Moreover, in the above embodiment, the display device 200 comprises an LCD, EL display, or the like by way of example. The display device 200 according to the present disclosure is not restricted thereto. For example, the display device 200 may be a projector projecting images or video images. In such a case, the display surface 201 is a screen on which the images or video images are projected.

Moreover, in the above embodiment, the outlines of the items I1 to I5 are made thicker for highlighting the item corresponding to the position of the user's hand 2 on the display surface 201 by way of example. However, the method of highlighting an item is not restricted thereto and moreover, whether or not to highlight an item is an arbitrary matter. For example, an item may be blinked or changed in color for highlighting. Moreover, when an item is displayed in text, the text may be changed in font or boldfaced for highlighting. Moreover, instead of highlighting the item displayed at the position of the user's hand 2 on the display surface 201, a pointer corresponding to the position of the user's hand 2 on the display surface 201 may be displayed on the display surface 201.

Moreover, in the above embodiment, the user's hand 2 functions as the operator operating the items by way of example. However, the operator is not restricted to the user's hand 2 and may be another part of the user's body; anything is applicable on an arbitrary basis as long as the operation target is operable. For example, the operator may be a remote controller held by the user in his hand.

Moreover, in the above embodiment, the data structure of items saved in the items DB 321 comprises two hierarchy levels. However, the data structure of items of which display is controllable by the display control device 300 according to the present disclosure is not restricted thereto. The item data structure may comprise a larger number of hierarchy levels. In such a case, the items belonging to a hierarchy level corresponding to the distance between the display surface 201 and user's hand 2 can be displayed on the display surface 201 by setting a given number of thresholds depending on the number of hierarchy levels, whereby the same efficacy as the above embodiment can be obtained.

Moreover, in displaying the immediate subordinate items of an item corresponding to the position of the user's hand 2 on the display surface 201 in the above embodiment, the display controller 313 does not display on the display surface 201 the other items belonging to the same hierarchy level as the item corresponding to the position of the user's hand 2 by way of example. However, the other items may be displayed on the display surface 201 while the immediate subordinate items are displayed. Moreover, the other items can be displayed in any fashion. For example, a translucent layer may be superimposed on the other items in display so that the item corresponding to the position of the user's hand 2 and the immediate subordinate items of the item are displayed more clearly than the other items.

Moreover, in the above embodiment, the display controller 313 displays the immediate subordinate items of an item corresponding to the position of the user's hand 2 on the display surface 201. However, when there is no item corresponding to the position of the user's hand 2, in other words when no item is displayed at the position of the user's hand 2, the immediate subordinate items of the item closest to the position of the user's hand 2 may be displayed. Moreover, in such a case, there may be no display of items at a different hierarchy level.

Moreover, the display control device 300 according to the present disclosure can be realized by a conventional computer, not by a dedicated device. For example, a computer may execute programs to realize the display control device 300. The programs for realizing the functions of the display control device 300 may be stored in a non-transitory computer-readable recording medium such as a universal serial bus (USB) memory, compact disc read only memory (CD-ROM), digital versatile disc (DVD), and HDD, or downloaded to a computer via a network.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A display control device, comprising:
a distance acquirer acquiring a distance between a display surface on which an item is displayed and an operator operating the item; and
a display controller displaying on the display surface an item belonging to a hierarchy level corresponding to the distance acquired by the distance acquirer from an item group including multiple hierarchized items.

2. The display control device according to claim 1, wherein the display controller displays on the display surface an item belonging to a deeper hierarchy level as the distance acquired by the distance acquirer is shorter.

3. The display control device according to claim 1, further comprising:
a position acquirer acquiring a position on the display surface that is specified by the operator,
wherein the display controller displays on the display surface an immediate subordinate item of an item corresponding to the position acquired by the position acquirer when the distance acquired by the distance acquirer falls below a given threshold.

4. The display control device according to claim 2, further comprising:
a position acquirer acquiring a position on the display surface that is specified by the operator,
wherein the display controller displays on the display surface an immediate subordinate item of an item corresponding to the position acquired by the position acquirer when the distance acquired by the distance acquirer falls below a given threshold.

5. The display control device according to claim 3, wherein the display controller displays on the display surface an immediate superior item of an item displayed on the display surface and an item belonging to the same hierarchy level as the immediate superior item when the distance acquired by the distance acquirer exceeds the given threshold.

6. The display control device according to claim 4, wherein the display controller displays on the display surface an immediate superior item of an item displayed on the display surface and an item belonging to the same hierarchy level as the immediate superior item when the distance acquired by the distance acquirer exceeds the given threshold.

7. The display control device according to claim 1, wherein the operator is a part of a user.

8. The display control device according to claim 2, wherein the operator is a part of a user.

9. The display control device according to claim 3, wherein the operator is a part of a user.

10. The display control device according to claim 4, wherein the operator is a part of a user.

11. The display control device according to claim 5, wherein the operator is a part of a user.

12. The display control device according to claim 6, wherein the operator is a part of a user.

13. A display control device, comprising:
a distance acquirer acquiring a distance between a display surface on which an item is displayed and an operator operating the item;
a position acquirer acquiring a position on the display surface that is specified by the operator; and
a display controller displaying on the display surface an item relating to an item corresponding to the position acquired by the position acquirer when the distance acquired by the distance acquirer falls below or exceeds a given threshold.

14. A display control method for a display control device comprising a distance acquirer acquiring a distance between a display surface on which an item is displayed and an operator operating the item, including:
a display control step of displaying on the display surface an item belonging to a hierarchy level corresponding to the distance acquired by the distance acquirer from an item group including multiple hierarchized items.

15. A display control method for a display control device comprising a distance acquirer acquiring a distance between a display surface on which an item is displayed and an operator operating the item, including:
a position acquisition step of acquiring a position on the display surface that is specified by the operator; and
a display control step of displaying on the display surface an item relating to an item corresponding to the position acquired in the position acquisition step when the distance acquired by the distance acquirer falls below or exceeds a given threshold.

16. A non-transitory computer-readable recording medium saving a program including a series of commands executed by a computer built in a display control device comprising a distance acquirer acquiring a distance between a display surface on which an item is displayed and an operator operating the item, the program causing the computer to function as:
a display controller displaying on the display surface an item belonging to a hierarchy level corresponding to the distance acquired by the distance acquirer from an item group including multiple hierarchized items.

17. A non-transitory computer-readable recording medium saving a program including a series of commands executed by a computer built in a display control device comprising a distance acquirer acquiring a distance between a display surface on which an item is displayed and an operator operating the item, the program causing the computer to function as:
a position acquirer acquiring a position on the display surface that is specified by the operator; and
a display controller displaying on the display surface an item relating to an item corresponding to the position acquired by the position acquirer when the distance acquired by the distance acquirer falls below or exceeds a given threshold.
